(19) United States
(12) Patent Application Publication
(10) Pub. No.: US 2012/0020642 A1
(43) Pub. Date: Jan. 26, 2012

(54) METHOD FOR DETECTING PROGRAM OVERLAPPING PORTION AND AUDIO/VIDEO RECORDING DEVICE USING THE SAME

(75) Inventor: Masaki TOYOKURA, Hyogo (JP)

(73) Assignee: Panasonic Corporation, Osaka (JP)

(21) Appl. No.: 13/253,562

(22) Filed: Oct. 5, 2011

Related U.S. Application Data
(63) Continuation of application No. PCT/JP2009/005885, filed on Nov. 5, 2009.

(30) Foreign Application Priority Data
Apr. 24, 2009 (JP) 2009-106900

(51) Int. Cl. H04N 9/80

(52) U.S. Cl. 386/241; 386/E09.011

(57) ABSTRACT

A data recorder records (n−1)th episode data and n-th episode data of a drama series, where n is an integer of two ore more. An audio decoder generates respective audio data of these episodes. An overlapping portion determiner extracts and compares a tail portion of the audio data of the (n−1)th episode and a head portion of the audio data of the n-th episode to detect an overlapping portion, and records an overlapping time between the (n−1)th and n-th episodes to an overlapping time storage. A recorded data editor deletes a portion of the (n−1)th episode data corresponding to the overlapping time recorded in the overlapping time storage, from a tail end of the (n−1)th episode data, and records the resulting (n−1)th episode data as (n−1)th episode edited data to the data recorder.

### CROSS-REFERENCE TO RELATED APPLICATIONS

This is a continuation of PCT International Application PCT/JP2009/005885 filed on Nov. 5, 2009, which claims priority to Japanese Patent Application No. 2009-106900 filed on Apr. 24, 2009. The disclosures of these applications including the specifications, the drawings, and the claims are hereby incorporated by reference in their entirety.

### BACKGROUND

The present disclosure relates to techniques of reproducing, recording, and editing recorded data of programs having continuity in devices, or external boards and software for personal computers, which have a TV broadcast receiving function.

Video recorders or video recording software for personal computers, which record video in a recording medium, such as a DVD, a BD, an HDD, a flash memory, etc., have a function of performing programmed recording using program data called “electric program guide (EPG)” acquired via broadcasting or the Internet. A drama series which is broadcast every week may be designated by a user using EPG information and recorded every week. This function enables the user to program the video recorder or video recording software to record an entire drama series which the user wants to view without programming for each episode (program), resulting in high convenience.

In general, there is a similarity in structure between episodes of a drama series. There is a known recorder which utilizes the similarity. In this recorder, if the first episode is edited in a manner desired by the user, information about the edition is extracted and recorded. The second episode and thereafter will be automatically edited in a manner similar to that of the first episode using the edition information of the first episode (see Japanese Patent Publication No. 2008-245219).

In the above conventional example, when a drama series is edited, the second episode and thereafter are automatically edited using edition information extracted when the first episode is edited. In some drama series, a last part of the (n−1)th episode may be repeated in a beginning part of the n-th episode, where n is an integer of two or more. In this case, when an entire drama series is recorded, the repeating portion (overlapping portion) may be redundant in terms of recorded data. If the overlapping portion is removed from the recorded data, recording media can be saved, and the user does not have to view the overlapping portion when playing the recorded data. In the conventional example, however, the overlapping portion cannot be extracted and therefore cannot be efficiently removed, and cannot be removed by the automatic edition function.

### SUMMARY

The present disclosure describes implementations of a system in which an overlapping portion between the current episode and the previous episode can be presented, or can be deleted in automatic edition, whereby recording media can be saved or the viewing of the overlapping portion can be skipped.

An example audio/video recording device of the present disclosure includes means for extracting an overlapping portion between the (n−1)th episode and the n-th episode, where n is an integer of two or more, whereby the (n−1)th episode and the n-th episode are edited or reproduced by utilizing the overlapping time.

Specifically, an example audio/video recording device includes means for extracting an overlapping portion between the (n−1)th episode and the n-th episode, thereby deleting data of the overlapping portion between the (n−1)th episode and the n-th episode in automatic edition.

Another example audio/video recording device may also include means for extracting an overlapping portion between the (n−1)th episode and the n-th episode, thereby skipping the overlapping portion from the head end of the n-th episode and reproducing the following portion of the n-th episode.

Another example audio/video recording device may also include means for extracting an overlapping portion between the (n−1)th episode and the n-th episode, thereby simultaneously reproducing the overlapping portions of the (n−1)th episode and the n-th episode in manual edition.

An example program overlapping portion detection method includes the steps of extracting a portion of (n−1)th episode data corresponding to a time period Δ preceding a tail end of the (n−1)th episode data by a time length T(m), extracting a portion of the n-th episode data corresponding to the time period Δ from a head end of the n-th episode data, calculating the sum of differences between sampled portions of the extracted data portions while m is changed within a predetermined range, comparing the difference sums changing with m, and determining a time length T(p) corresponding to the extracted data portion of the (n−1)th episode data having a smallest value of the difference sum, and determining that the extracted data portion of the (n−1)th episode data having the smallest difference sum is an overlapping portion between the (n−1)th episode data and the n-th episode data.

Another example program overlapping portion detection method includes the steps of extracting a portion of (n−1)th episode data corresponding to a time period Δ(m) from a tail end of the (n−1)th episode data, extracting a portion of n-th episode data corresponding to the time period Δ(m) from a head end of the n-th episode data, calculating the sum of differences between sampled portions of the extracted data portions, and dividing the difference sum by the time period Δ(m) to obtain an average difference E(m) while m is changed within a predetermined range, comparing the average differences E(m), and determining a time period Δ(p) corresponding to the extracted data portion having a smallest value of the average difference E(m), and determining that the extracted data portion having the smallest average difference E(m) is an overlapping portion between the (n−1)th episode data and the n-th episode data.

The means for extracting the overlapping portion between the (n−1)th episode and the n-th episode enables the use of a data time position of the overlapping portion, whereby the overlapping portion of a drama series can be removed in automatic edition, and therefore, the capacity of recording media can be reduced. Also, by skipping the overlapping portion from the head end of the n-th episode and reproduce the following portion, the viewing time can be reduced. Also, by simultaneously reproducing the overlapping portions of the (n−1)th episode and the n-th episode, the user can confirm a candidate portion to be removed in manual edition, whereby the efficiency of edition can be increased.

### BRIEF DESCRIPTION OF THE DRAWINGS

FIG. 1 is a block diagram showing an example configuration of an audio/video recording device according to the present disclosure.

FIG. 2 is a flowchart showing a program overlapping portion detection method according to the present disclosure.

FIG. 3 is a diagram showing a relationship between extracted data portions in the program overlapping portion detection method of FIG. 2.

FIG. 4 is another flowchart showing the program overlapping portion detection method of the present disclosure.

FIG. 5 is a diagram showing a relationship between extracted data portions in the program overlapping portion detection method of FIG. 4.

FIG. 6 is a block diagram showing another example configuration of the audio/video recording device of the present disclosure.

FIG. 7 is a block diagram showing still another example configuration of the audio/video recording device of the present disclosure.

FIG. 8 is a diagram showing a data relationship when a candidate portion to be deleted is reproduced during edition of a drama series in the audio/video recording device of FIG. 7.

### DETAILED DESCRIPTION

### First Embodiment

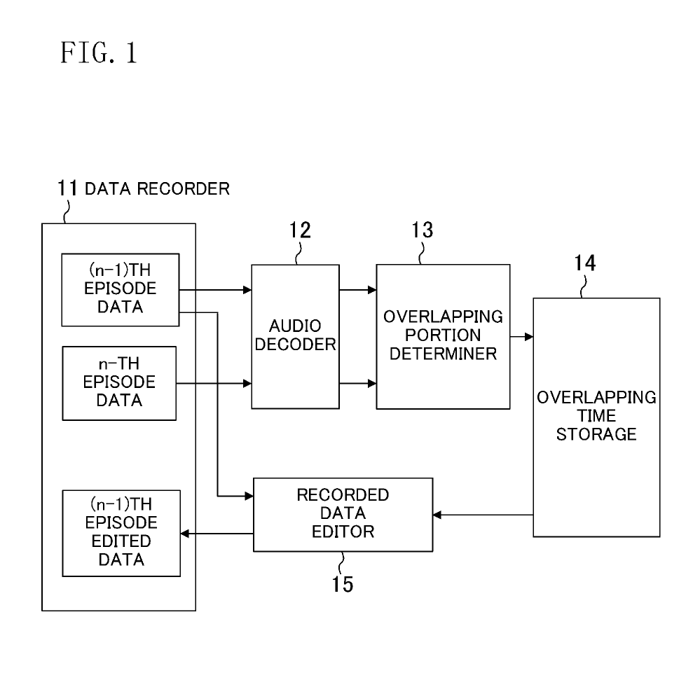

A configuration of an audio/video recording device according to the present disclosure will be described with reference to FIG. 1. The audio/video recording device of FIG. 1 includes a data recorder 11, an audio decoder 12, an overlapping portion determiner 13, an overlapping time storage 14, and a recorded data editor 15.

The data recorder 11 records (n−1)th episode data and n-th episode data of a drama series (n is an integer of two or more). The data may be recorded in various formats. In the case of analog TV broadcasts, the data may be recorded in a compressed stream format. In the case of digital TV broadcasts, the data may be recorded in the same stream format that is used during broadcasting, or may be recorded in a re-encoded stream format. The audio decoder 12 reads the (n−1)th episode data and the n-th episode data from the data recorder 11, and decodes respective audio portions thereof. The audio decoder 12 separates an audio stream based on information indicating audio in the stream, and decodes the audio stream to generate audio data of the (n−1)th episode and audio data of the n-th episode. The overlapping portion determiner 13 receives the audio data of the (n−1)th episode and the audio data of the n-th episode, extracts a tail portion (partial data) of the audio data of the (n−1)th episode and a head portion (partial data) of the audio data of the n-th episode, compares these portions to detect an overlapping portion, and records the detection result as an overlapping time between the (n−1)th episode and the n-th episode to the overlapping time storage 14. The recorded data editor 15 reads the (n−1)th episode data from the data recorder 11, removes data corresponding to the overlapping time between the (n−1)th episode and the n-th episode recorded in the overlapping time storage 14 from the tail end of the (n−1)th episode data, and records the resulting (n−1)th episode data as (n−1)th episode edited data to the data recorder 11.

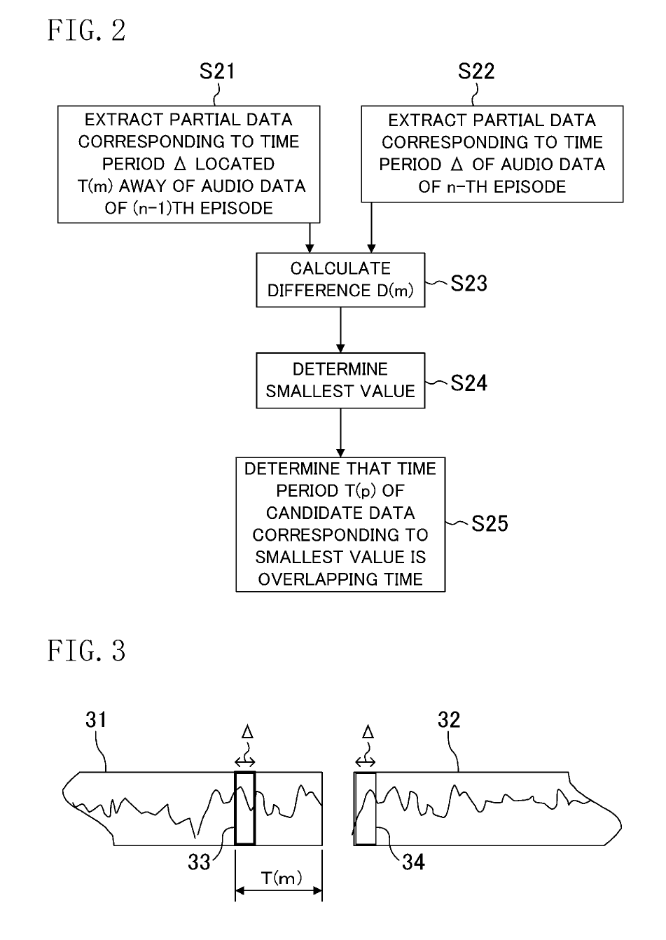

The process of the overlapping portion determiner 13 will be described with reference to FIG. 2. In S21, partial data located a time length T(m) away from the tail end of the audio data of the (n−1)th episode is extracted from the audio data of the (n−1)th episode. In S22, partial data is extracted from the head end of the audio data of the n-th episode. These partial data portions have the same time period Δ.

In S23, a difference D(m) between the partial data located the time length T(m) away of the audio data of the (n−1)th episode and the partial data of the audio data of the n-th episode. For example, the difference D(m) may be calculated as the sum of the absolute values of partial data differences of sampled values:

$$D ( m ) = {\sum }_{i = 0}^{Δ - 1} \vert {A}_{n - 1} ( m , i ) - {A}_{n} ( i ) \vert \qquad ( 1 )$$

where i represents each sampling time of the partial data in the time period Δ, Aₙ₋₁(m, i) represents the partial data located the time length T(m) away of the audio data of the (n−1)th episode, and Aₙ(i) represents the partial data of the audio data of the n-th episode.

Alternatively, the difference D(m) may be calculated as the sum of the squares of partial data differences of sampled values:

$$D ( m ) = {\sum }_{i = 0}^{Δ - 1} {( {A}_{n - 1} ( m , i ) - {A}_{n} ( i ) )}^{2} \qquad ( 2 )$$

These techniques are known in the field of pattern recognition etc.

In S24, the value of m which minimizes the difference D(m) is determined and represented by p. In S25, it is determined that a time period T(p) corresponding to p selected in S24 is the overlapping time.

A relationship between the extracted data and the process will be described with reference to FIG. 3. In FIG. 3, a reference character 31 indicates the audio data of the (n−1)th episode, a reference character 32 indicates the audio data of the n-th episode, a reference character 33 indicates partial data corresponding to the time period Δ of the (n−1)th episode, and a reference character 34 indicates partial data corresponding to the time period Δ of the n-th episode. The partial data 33 corresponding to the time period Δ of the (n−1)th episode is extracted from a position which is located the time length T(m) away from the tail end of the audio data 31 of the (n−1)th episode (i.e., the time period Δ of the partial data 33 begins at a time position offset by the time length T(m) from the tail end of the audio data 31 of the (n−1)th episode), and is represented by Aₙ₋₁(m, i). The partial data 34 corresponding to the time period Δ of the n-th episode is extracted from the head end of the audio data 32 of the n-th episode (i.e., the time period Δ of the partial data 34 begins at the head end of the audio data 32 of the n-th episode), and is represented by Aₙ(i). While T(m) is changed within a predetermined range, partial data of the (n−1)th episode is extracted and compared with partial data of the n-th episode. The most matching partial data is considered as an overlapping portion between the (n−1)th episode and the n-th episode. The T(m) in this case is represented by T(p). It is determined that the overlapping time is T(p).

By the method described above, the recorded data editor 15 can remove the overlapping portion between the (n−1)th episode data and the n-th episode data, whereby the capacity of a medium for recording data can be reduced, and a larger amount of program data can be recorded.

Note that the recorded data editor 15 may read the n-th episode data from the data recorder 11 and remove data corresponding to the overlapping time between the (n−1)th episode and the n-th episode recorded in the overlapping time storage 14 from the head end of the n-th episode data.

For the time length T(m), a minimum time period and a maximum time period may be set, whereby the time required for the determination can be reduced.

### Second Embodiment

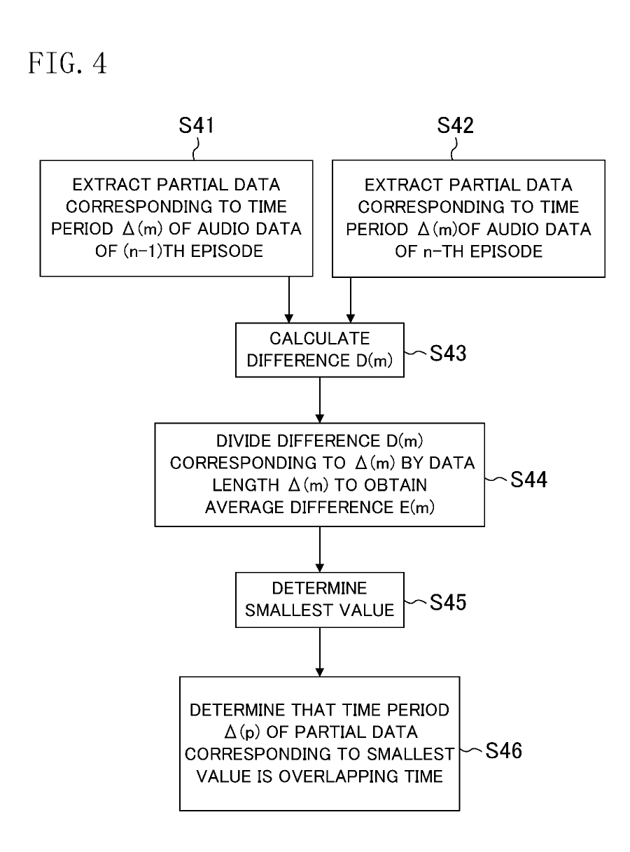

Another process performed by the overlapping portion determiner 13 will be described with reference to FIG. 4. In S41, partial data corresponding to a time period Δ(m) is extracted from the audio data of the (n−1)th episode. In S42, partial data corresponding to the time period Δ(m) is extracted from the audio data of the n-th episode.

In S43, a difference D(m) between the partial data of the audio data of the (n−1)th episode and the partial data of the audio data of the n-th episode is calculated. Similar to the first embodiment, the difference D(m) may be calculated by:

$$D ( m ) = {\sum }_{i = 0}^{Δ ( m ) - 1} \vert {A}_{n - 1} ( m , i ) - {A}_{n} ( m , i ) \vert \qquad ( 3 )$$

where i represents each sampling time of the partial data in the time period Δ(m), Aₙ₋₁(m, i) represents the partial data corresponding to the time period Δ(m) of the audio data of the (n−1)th episode, and Aₙ(m, i) represents the partial data corresponding to the time period Δ(m) of the audio data of the n-th episode.

Alternatively, the difference D(m) may be calculated by:

$$D ( m ) = {\sum }_{i = 0}^{Δ ( m ) - 1} {( {A}_{n - 1} ( m , i ) - {A}_{n} ( m , i ) )}^{2} \qquad ( 4 )$$

In S44, an average difference E(m) is calculated by dividing the difference D(m) by the time period Δ(m):

E(m)=D(m)/Δ(m) (5)

The time period Δ(m) changes with m. In order to prevent the variable time period Δ(m), which is a data length, from causing matching error when the difference D(m) calculated based on expression (3) or (4) is compared between each m, the difference values are normalized.

In S45, m which minimizes the average difference E(m) is found and represented by p. In S46, it is determined that the time period Δ(p) corresponding to p found in S45 is the overlapping time.

A relationship between the extracted data and the process will be described with reference to FIG. 5. In FIG. 5, a reference character 51 indicates the audio data of the (n−1)th episode, a reference character 52 indicates the audio data of the n-th episode, a reference character 53 indicates partial data having the length Δ(m) of the (n−1)th episode, and a reference character 54 indicates partial data having the length Δ(m) of the n-th episode. The partial data 53 having the length Δ(m) of the (n−1)th episode is extracted from the tail end of the audio data 51 of the (n−1)th episode (i.e., the partial data extends by the length Δ(m) from the tail end of the audio data 51 of the (n−1)th episode), and is represented by Aₙ₋₁(m, i). The partial data 54 having the length Δ(m) of the n-th episode is extracted from the head end of the audio data 52 of the n-th episode (i.e., the partial data 54 extends by the length Δ(m) from the head end of the audio data 52 of the n-th episode), and is represented by Aₙ(m, i). While Δ(m) is changed within a predetermined range, partial data of the (n−1)th episode is extracted and compared with partial data of the n-th episode. The most matching partial data is considered as an overlapping portion between the (n−1)th episode and the n-th episode. The time period Δ(m) in this case is represented by Δ(p). It is determined that the overlapping time is Δ(p).

For the time period Δ(m), a minimum time period and a maximum time period may be set, whereby the time required for the determination can be reduced.

### Third Embodiment

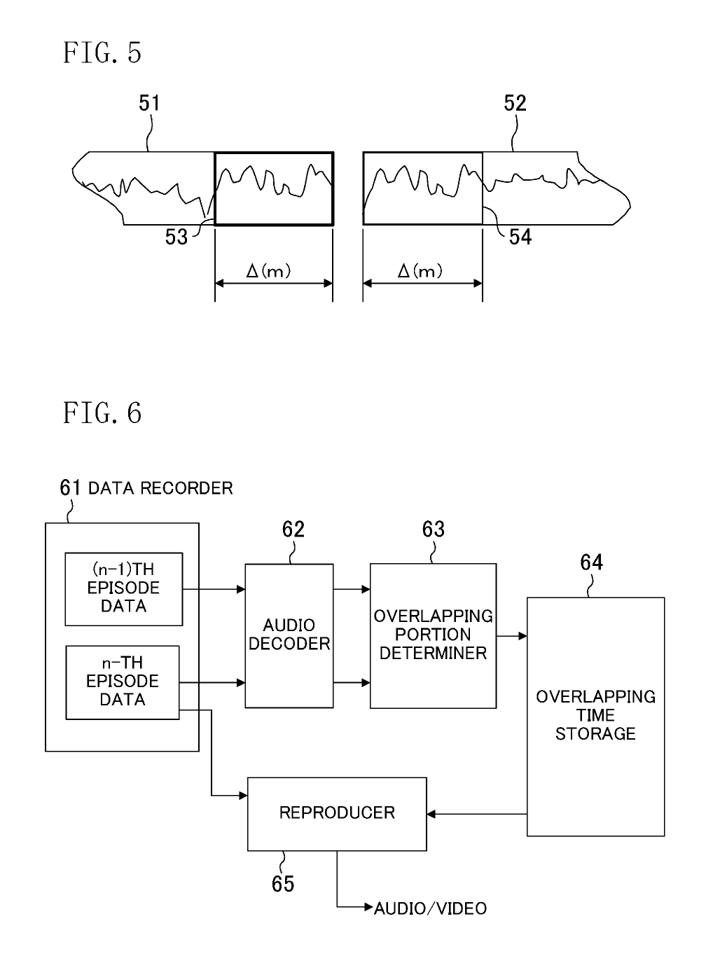

Another configuration of the audio/video recording device of the present disclosure will be described with reference to FIG. 6. The audio/video recording device of FIG. 6 includes a data recorder 61, an audio decoder 62, an overlapping portion determiner 63, an overlapping time storage 64, and a reproducer 65.

The data recorder 61 records (n−1)th episode data and n-th episode data of a drama series. The data may be recorded in various formats. In the case of analog TV broadcasts, the data may be recorded in a compressed stream format. In the case of digital TV broadcasts, the data may be recorded in the same stream format that is used during broadcasting, or may be recorded in a re-encoded stream format. The audio decoder 62 reads the (n−1)th episode data and the n-th episode data from the data recorder 61, and decodes respective audio portions thereof. The audio decoder 62 separates an audio stream based on information indicating audio in the stream, and decodes the audio stream to generate audio data of the (n−1)th episode and audio data of the n-th episode. The overlapping portion determiner 63 receives the audio data of the (n−1)th episode and the audio data of the n-th episode, extracts a tail portion (partial data) of the audio data of the (n−1)th episode and a head portion (partial data) of the audio data of the n-th episode, compares these portions to detect an overlapping portion, and records the detection result as an overlapping time between the (n−1)th episode and the n-th episode to the overlapping time storage 64. The reproducer 65 reads the n-th episode data from the data recorder 61, skips a head portion of the n-th episode data corresponding to the overlapping time between the (n−1)th episode and the n-th episode, and reproduces the following portion of the n-th episode data.

### Fourth Embodiment

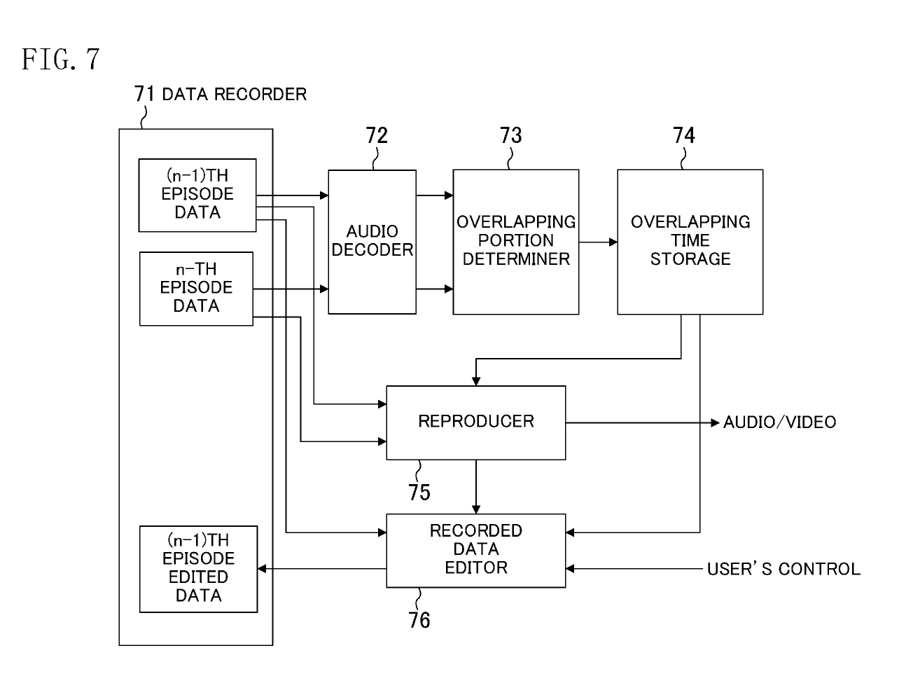

Still another configuration of the audio/video recording device of the present disclosure will be described with reference to FIG. 7. The audio/video recording device of FIG. 7 includes a data recorder 71, an audio decoder 72, an overlapping portion determiner 73, an overlapping time storage 74, a reproducer 75, and a recorded data editor 76.

The data recorder 71 records (n−1)th episode data and n-th episode data of a drama series. The data may be recorded in various formats. In the case of analog TV broadcasts, the data may be recorded in a compressed stream format. In the case of digital TV broadcasts, the data may be recorded in the same stream format that is used during broadcasting, or may be recorded in a re-encoded stream format. The audio decoder 72 reads the (n−1)th episode data and the n-th episode data from the data recorder 71, and decodes respective audio portions thereof. The audio decoder 72 separates an audio stream based on information indicating audio in the stream, and decodes the audio stream to generate audio data of the (n−1)th episode and audio data of the n-th episode. The overlapping portion determiner 73 receives the audio data of the (n−1)th episode and the audio data of the n-th episode, extracts a tail portion (partial data) of the audio data of the (n−1)th episode and a head portion (partial data) of the audio data of the n-th episode, compares these portions to detect an overlapping portion, and records the detection result as an overlapping time between the (n−1)th episode and the n-th episode to the overlapping time storage 74. When the recorded episodes are edited, the reproducer 75 reads the (n−1)th episode data and the n-th episode data from the data recorder 71, and simultaneously reproduces these data. In this case, the (n−1)th episode data is reproduced from a time position which precedes the tail end of the (n−1)th episode data by the overlapping time between the (n−1)th episode and the n-th episode recorded in the overlapping time storage 74, while the n-th episode data is reproduced from the head end thereof.

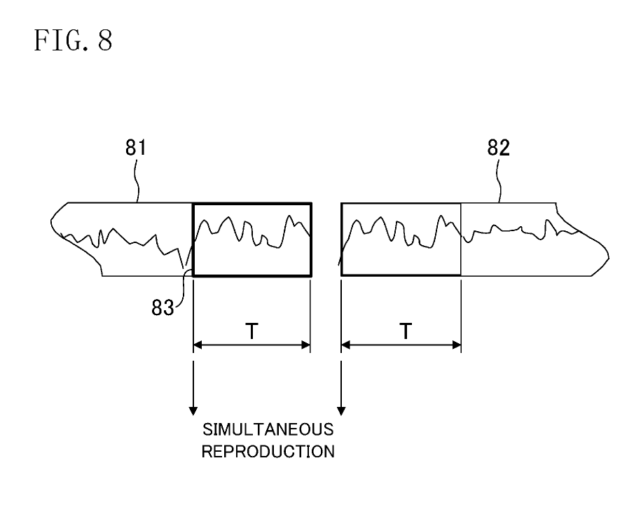

A relationship in time between data simultaneously reproduced will be described with reference to FIG. 8. In FIG. 8, a reference character 81 indicates the audio data of the (n−1)th episode, a reference character 82 indicates the audio data of the n-th episode, and a P054298 reference character 83 indicates a time position preceding the tail end of the (n−1)th episode by the overlapping time T between the (n−1)th episode and the n-th episode recorded in the overlapping time storage 74. The (n−1)th episode is reproduced from the data position 83 which precedes the tail end of the (n−1)th episode by the overlapping time T between the (n−1)th episode and the n-th episode recorded in the overlapping time storage 74, while the n-th episode is reproduced from the head end thereof. By simultaneously reproducing the (n−1)th episode and the n-th episode, the user can confirm candidate data to be deleted.

If the user determines that the candidate data can be deleted, the user instructs the audio/video recording device to delete the candidate data. In this case, the recorded data editor 76 reads the (n−1)th episode data from the data recorder 71, deletes a portion of the (n−1)th episode data corresponding to the overlapping time between the (n−1)th episode and the n-th episode recorded in the overlapping time storage 74 from the tail end of the (n−1)th episode data, and records the resulting data as (n−1)th episode edited data to the data recorder 71.

Note that, similar to the first embodiment, the overlapping portion may be deleted from the head end of the n-th episode data.

As described above, the program overlapping portion detection method of the present disclosure and the audio/video recording device employing the method can provide a system in which an overlapping portion of a drama series can be presented, or can be deleted in automatic edition, whereby recording media can be saved or the viewing of the overlapping portion can be skipped. Therefore, the present disclosure is useful for devices, or external boards and software for personal computers, which have a TV broadcast receiving function.

What is claimed is:

1. An audio/video recording device comprising:
a data recorder configured to record (n−1)th episode data and n-th episode data of a drama series, where n is an integer of two ore more;
an audio decoder configured to receive the (n−1)th episode data and the n-th episode data from the data recorder, and decode respective audio portions thereof to generate audio data of the (n−1)th episode and audio data of the n-th episode;
an overlapping time storage configured to store an overlapping time between the (n−1)th episode and the n-th episode; and
an overlapping portion determiner configured to receive the audio data of the (n−1)th episode and the audio data of the n-th episode, extract and compare a tail portion of the audio data of the (n−1)th episode and a head portion of the audio data of the n-th episode to detect an overlapping portion, and record a result of the detection as the overlapping time between the (n−1)th episode and the n-th episode to the overlapping time storage, wherein
in edition or reproduction, the overlapping time between the (n−1)th episode and the n-th episode is read from the overlapping time storage and is used.

2. The audio/video recording device of claim 1, further comprising:
a recorded data editor configured to read the (n−1)th episode data from the data recorder, delete a portion of the (n−1)th episode data corresponding to the overlapping time between the (n−1)th episode and the n-th episode recorded in the overlapping time storage, from a tail end of the (n−1)th episode data, and record the resulting (n−1)th episode data as (n−1)th episode edited data to the data recorder.

3. The audio/video recording device of claim 1, further comprising:
a reproducer configured to read the n-th episode data from the data recorder, skip a portion of the n-th episode data corresponding to the overlapping time between the (n−1)th episode and the n-th episode recorded in the overlapping time storage from a head end of the n-th episode data, and reproduce a portion of the n-th episode data following the skipped portion.

4. The audio/video recording device of claim 1, further comprising:
a reproducer configured to read the (n−1)th episode data and the n-th episode data from the data recorder, and simultaneously reproduce the (n−1)th episode from a time position preceding a tail end thereof by the overlapping time between the (n−1)th episode and the n-th episode recorded in the overlapping time storage, and the n-th episode data from a head end thereof; and
a recorded data editor configured to receive a user's instruction produced based on a result of the reproduction, and in response to the user's instruction, read the (n−1)th episode data from the data recorder, delete from a tail end of the (n−1)th episode data a portion of the (n−1)th episode data corresponding to the overlapping time between the (n−1)th episode and the n-th episode recorded in the overlapping time storage, and record the resulting (n−1)th episode data as (n−1)th episode edited data to the data recorder.

5. A program overlapping portion detection method for use in an audio/video recording device, comprising the steps of:
extracting a portion of (n−1)th episode data corresponding to a time period Δ preceding a tail end of the (n−1)th episode data by a time length T(m), where n is an integer of two or more;
extracting a portion of the n-th episode data corresponding to the time period Δ from a head end of the n-th episode data;
calculating the sum of differences between sampled portions of the extracted data portions while m is changed within a predetermined range;
comparing the difference sums changing with m; and
determining a time length T(p) corresponding to the extracted data portion of the (n−1)th episode data having a smallest value of the difference sum, and determining that the extracted data portion of the (n−1)th episode data having the smallest difference sum is an overlapping portion between the (n−1)th episode data and the n-th episode data.

6. A program overlapping portion detection method for use in an audio/video recording device, comprising the steps of:
extracting a portion of (n−1)th episode data corresponding to a time period Δ(m) from a tail end of the (n−1)th episode data, where n is an integer of two or more;
extracting a portion of n-th episode data corresponding to the time period Δ(m) from a head end of the n-th episode data;
calculating the sum of differences between sampled portions of the extracted data portions, and dividing the difference sum by the time period Δ(m) to obtain an average difference E(m) while m is changed within a predetermined range;
comparing the average differences E(m); and
determining a time period Δ(p) corresponding to the extracted data portion having a smallest value of the average difference E(m), and determining that the extracted data portion having the smallest average difference E(m) is an overlapping portion between the (n−1)th episode data and the n-th episode data.
